(19) United States
(12) Patent Application Publication
(10) Pub. No.: US 2015/0154560 A1
(43) Pub. Date: Jun. 4, 2015

(54) OPTIMAL PRIORITIZATION OF BUSINESS LISTINGS FOR MODERATION

(71) Applicant: Paul Eastlund, Mamaroneck, NY (US)

(72) Inventor: Paul Eastlund, Mamaroneck, NY (US)

(73) Assignee: GOOGLE INC., Mountain View, CA (US)

(21) Appl. No.: 12/986,521

(22) Filed: Jan. 7, 2011

(51) Int. Cl. G06Q 10/10; G06Q 10/00

(52) U.S. Cl. CPC G06Q 10/10

(57) ABSTRACT

A moderation priority server is operative to prioritize one or more business listings. The moderation priority server may include a business listing database comprising a plurality of business listings and one or more pipelines for processing the various business listings. The moderation priority server may include a moderation priority queue, where business listings to be moderated are prioritized. The business listings may be prioritized based on a publishing value, which may indicate a value of publishing the business listing, and a suppressing value, which may indicate a value of suppressing the business listing. When the publishing value exceeds the suppressing value, the moderation priority server may indicate that the business listing is to be published, and, when the suppressing value exceeds the publishing value, the moderation priority server may indicate that the business listing is to be suppressed.

### BACKGROUND

One of the challenges in providing business listings to the public is that a business listing provider must take care to ensure that its listings are free of errors. The errors may range in severity, from being low in severity where the error in the business listing may be in the type of the business, to being high in severity where the error in the business listing may be in the identifying information for the business, such as a street address, phone number, or other identifying information. Taking care to correct errors in a business listing is problematic because publishing a business listing with errors may be more detrimental than deciding not to publish (i.e., suppress) the business listing.

A person may review a business listing to determine whether the business information contains errors; however, this process is a time consuming task. Moreover, when a publisher provides a business listing database containing thousands of business listings to help the public access information about the listed businesses, reviewing each business listing would take an inordinate amount of time and run the risk of publishing a business listing containing errors.

### BRIEF SUMMARY

An apparatus for an optimal prioritization of business listings for moderation is described. In one embodiment, the apparatus includes a memory operative to store a business listing database comprising a plurality of business listings a processor in communication with the memory, the processor being operative to determine a publishing value for a selected business listing of the plurality of business listings based on a probability that business information for the selected business listing is accurate, wherein the publishing value indicates a value of publishing the selected business listing. The processor is also operative to determine a suppressing value for the selected business listing based on the probability that the business information is not accurate, wherein the suppressing value indicates a value of suppressing the business listing. The processor is further operative to assign a first moderation priority to the selected business listing that indicates a priority of the selected business listing for moderation when the publishing value exceeds the suppressing value, and assign a second moderation priority different than the first moderation priority that indicates the priority of the selected business listing for moderation when the suppressing value exceeds the publishing value.

In one embodiment of the apparatus, the processor is further operative to update the business listing database to indicate that the selected business listing is to be published when the publishing value exceeds the suppressing value, and update the business listing database that the selected business listing is to be suppressed when the suppressing value exceeds the publishing value.

In another embodiment of the apparatus, the processor is further operative to update the business information of the selected business listing with a received update of business information from a business information source, re-determine the publishing value for the selected business listing based on a probability that the updated business information is accurate, re-determine the suppressing value for the selected business listing based on the probability that the updated business information is not accurate, assign a third moderation priority to the selected business listing that indicates a priority of the business listing for moderation when the re-determined publishing value exceeds the re-determined suppressing value, and assign a fourth moderation priority different than the third moderation priority, wherein the fourth moderation priority indicates that the priority of the selected business listing for moderation when the re-determined suppressing value exceeds the re-determined publishing value.

In a further embodiment of the apparatus, the apparatus further comprises a moderation priority queue, wherein the processor is further operative to assign one of the first moderation priority or the second moderation priority when the moderation priority queue is populated with the selected business listing.

In yet another embodiment of the apparatus, the moderation priority queue comprises a plurality of business listings to be moderated, and the business listings to be moderated are sorted according to an amount of moderation time required to moderate each of the business listings to be moderated.

In yet a further embodiment of the apparatus, the processor is operative to determine the publishing value of the selected business listing based on an expected number of impressions for the selected business listing and an estimated probability that the selected business listing is inaccurate.

In another embodiment of the apparatus, the processor is operative to determine the suppressing value of the selected business listing based on an expected number of impressions for the selected business listing and an estimated severity of a problem with the selected business listing.

In a further embodiment of the apparatus, the first moderation priority is based on an estimated probability that the selected business listing is inaccurate, an expected number of impressions for the selected business listing, and an estimated severity of a problem with the selected business listing.

In yet another embodiment of the apparatus, the second moderation priority is based on an estimated linear function of an expected number of impressions for the selected business listing.

In yet a further embodiment of the apparatus, the processor is further operative to prioritize the business listing based on a probability that the selected business listing has a fatal severity when the selected business listing has a problem and the selected business listing is to be suppressed.

A method for an optimal prioritization of business listings for moderation is also described. In one embodiment, the method comprises establishing, in a memory, a business listing database comprising a plurality of business listings determining, with a processor, a publishing value for a business listing selected from the plurality of business listings, wherein the publishing value is based on a probability that business information for the selected business listing is accurate and that indicates a value of publishing the business listing. The method may further comprise determining a suppressing value for the selected business listing based on the probability that the business information is accurate, wherein the suppressing value indicates a value of suppressing the selected business listing and assigning a first moderation priority to the selected business listing that indicates a priority of the selected business listing for moderation when the publishing value exceeds the suppressing value. The method may also comprise assigning a second moderation priority different than the first moderation priority that indicates the priority of the selected business listing for moderation when the suppressing value exceeds the publishing value.

In one embodiment of the method, the method further comprises indicating in the business listing database that the selected business listing is to be published when the publishing value exceeds the suppressing value, and indicating in the business listing database that the selected business listing is to be suppressed when the suppressing value exceeds the publishing value.

In another embodiment of the method, the method further comprises updating the business information of the selected business listing with a received update of business information from a business information source, re-determining the publishing value for the selected business listing based on a probability that the updated business information is accurate re-determining the suppressing value for the selected business listing based on the probability that the updated business information is not accurate assigning a third moderation priority to the selected business listing that indicates a priority of the selected business listing for moderation when the re-determined publishing value exceeds the re-determined suppressing value, and assigning a fourth moderation priority different than the third moderation priority, wherein the fourth moderation priority indicates the priority of the selected business listing for moderation when the re-determined suppressing value exceeds the re-determined publishing value.

In a further embodiment of the method, the method further comprises assigning the selected business listing one of the first moderation priority or the second moderation priority when a moderation priority queue is populated with the selected business listing.

In yet another embodiment of the method, the moderation priority queue comprises a plurality of business listings to be moderated, and the method further comprises sorting the business listings to be moderated according to an amount of moderation time required to moderate each of the business listings to be moderated.

In yet a further embodiment of the method, determining the publishing value of the selected business listing is based on an expected number of impressions for the selected business listing and an estimated probability that the selected business listing is inaccurate.

In another embodiment of the method, determining the suppressing value of the selected business listing is based on an expected number of impressions for the selected business listing and an estimated severity of a problem with the selected business listing.

In a further embodiment of the method, determining the first moderation priority is based on an estimated probability that the selected business listing is inaccurate, an expected number of impressions for the selected business listing, and an estimated severity of a problem with the selected business listing.

In yet another embodiment of the method, determining the second moderation priority is based on an estimated linear function of an expected number of impressions for the selected business listing.

In yet a further embodiment of the method, prioritizing the selected business listing is based on a probability that the selected business listing has a fatal severity when the selected business listing has a problem and the selected business listing is to be suppressed.

### BRIEF DESCRIPTION OF THE DRAWINGS

FIG. 1 illustrates one example of an apparatus for an optimal prioritization of business listings for moderation according to aspects of the invention.

FIG. 2 further illustrates the apparatus for the optimal prioritization of business listings for moderation according to aspects of the invention.

FIG. 3 illustrates one example of an external business information source pipeline for organizing received business information according to aspects of the invention.

FIGS. 4-5 illustrate one example of logic flow for assigning a priority to a business listing for moderation according to aspects of the invention.

### DETAILED DESCRIPTION

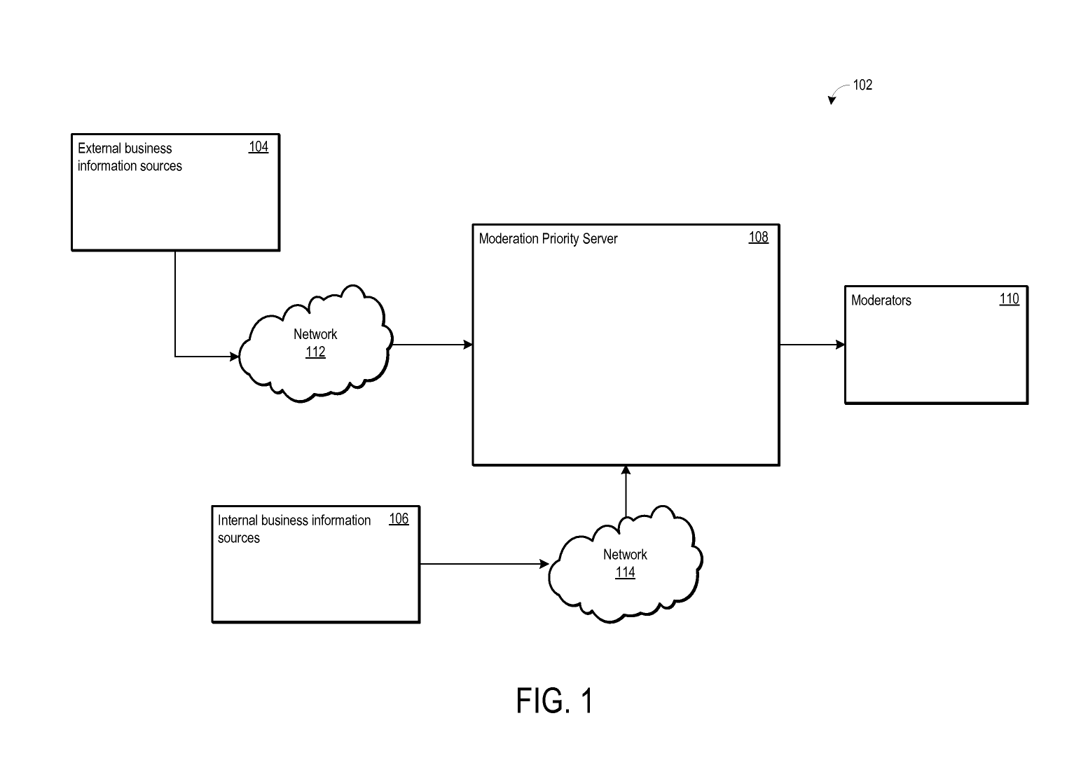

FIG. 1 illustrates one example of an apparatus 102 for an optimal prioritization of business listings for moderation. The apparatus 102 may include a moderation priority server 108 in communication with one or more external business information sources 104. The moderation priority server 108 may also communicate with one or more internal business information sources 106. The moderation priority server may also communicate with one or more moderators 110.

The external business information sources 106 may include any number and/or type of business information sources. For example, the external business information sources 106 may include webpages, Internet users, Internet service providers, Internet business providers (e.g., providers of online shopping, searching, etc.), or any other type of business information source.

The external business information sources 106 may provide the business information to the moderation priority server 108 actively, passively, or a combination thereof. An example of actively providing business information would be where an Internet user provides the business information to a business listing service, such as a restaurant review service, and the restaurant review service has asked the Internet user for information about the restaurant to be listed or reviewed. The restaurant review service may then communicate the business information received from the user to the moderation priority server 108. An example of passively providing business information would be where the moderation priority server 108 is in communication with an Internet search engine, and the Internet search engine indexes the business information from the webpage. As the Internet search engine is indexing the webpage, the moderation priority server 108 may organize the received business information into a new business listing.

The external business information sources 106 may be external to the moderation priority server 108 because the business information sources 106 may communicate with the moderation priority server 108 through one or more privately and public accessibly networks 112. For example, the moderation priority server 108 may operate on a privately accessible network, such as a local area network of a business, in communication with a publicly accessible network, such as the Internet. In this instance, a business information source may be external to the moderation priority server 108 when the business information source does not reside on the same privately accessible network as the moderation priority server 108. In more general terms, an external business information source may be an untrusted or less trusted business information source, where the reliability of the business information source is valued less than an internal business information source.

The business information provided by an external business information source 106 may be any type of information about a business. The business information may include the business's name, address, geographic location, geographic area of service, business type, number of employees, names or contact information of employees, or any other type of business information. Moreover, the business information provided by the external business information sources 106 may be incomplete, such that the external business information sources 106 may provide the business's name, but fail to provide the business's address or other business information. The moderation priority server 108 may also fill in the gaps in business information as it gathers the business information from additional external (or internal) business information sources 106. As discussed below, as additional business information for a business is gathered, the moderation priority server 108 may update a business listing for the business with the updated and/or additional business information.

In addition to communicating with external business information sources 106, the moderation priority server 108 may also communicate with internal business information sources 106 through one or more networks 114. An internal business information source may be a business information source residing on the same private network as the moderation priority server 108 or on the same set of private networks in communication with the moderation priority server 108. An example of an internal business information source may be a search engine that indexes webpages and provides the indexed business information to the moderation priority server 108, where the search engine and the moderation priority server 108 reside on the same private network or the same set of private networks. Another example of an internal business information source may be an employee of a company that communicates with the moderation priority server 108, where the employee provides updated or additional business information to the moderation priority server 108 for a new or existing business listing. Another example of an internal business information source 106 may be a client of operator of the moderation priority server 108, where the client notifies the moderation priority server 108 of outdated or incorrect business information regarding a business. In more general terms, an internal business information source may be a trusted business information source, where the reliability of the business information source is valued higher than an external business information source.

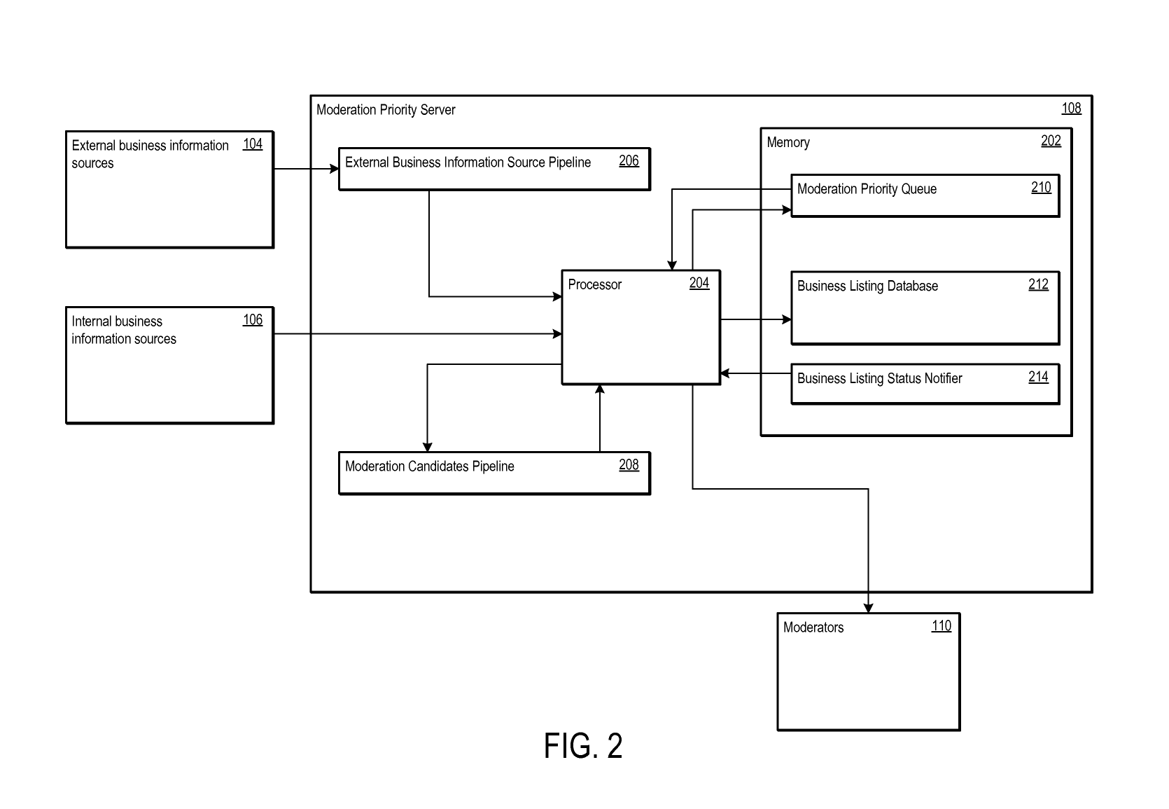

As mentioned above, the moderation priority server 108 may also be in communication with one or more moderators 110. As the moderation priority server 108 receives new and/or updated business information for a business listing, the moderation priority server 108 may update or create a business listing, and then prioritize the updated and/or created business listings based on the newly added and/or updated business information. One or more moderators 110, which may be human moderators or other types of moderators, may have access to the prioritized business listings to moderate the prioritized business listings. In this regard, a moderator need not moderate every business listing maintained by the moderation priority server 108, but rather, moderate those business listings that have been accordingly prioritized. The details of prioritizing a business listing are discussed with reference to FIGS. 2-5.

FIG. 2 illustrates one example of a moderation priority server 108 operative to prioritize one or more business listings for moderation by the one or more moderators 110. In one embodiment, the moderation priority server may include a memory 202, a processor 204, an external business information source pipeline 206, and a moderation candidates pipeline 208.

The memory 202 is operative to store a moderation priority queue 210, a business listing database 212 and a business listing status notifier 214. The business listing database 212 is operative to store a plurality of business listings. The business listings stored in the database 212 may contain the business information previously mentioned, such as a business name, a business address, a business phone, or any other business information. Moreover, the business listing database 212 may include one or more incomplete business listings, where the moderation priority server 108 updates the one or more incomplete business listings as it gathers additional business information from the external business information sources 104 and/or the internal business information sources 106.

The processor 204 may identify a business listing in the business listing database 212 as a business listing to be published or a business listing to be suppressed. A published business listing may be viewable and/or accessible outside of the moderation priority server 108. For example, the moderation priority server 108 may provide a published business listing to a search engine provider such that the business information of the published business listing is available to the search engine provider. A suppressed business listing is not viewable and/or accessible outside of the moderation priority server 108. Moreover, a business listing may be moderated by one or more moderators 110 regardless of whether the business listing is to be published or suppressed.

The external business information source pipeline 206 is operative to receive business information from the one or more external business information sources 104. The business information received by the external business information source pipeline 206 may be raw data, that is, information about a business that has not yet been identified as such. For example, the raw data may include a business telephone number, but the business telephone number may not have been identified. Instead, the moderation priority server 108 may merely view the business telephone number as a series of characters and/or digits. The processor 204 may be operative to organize the business information received from the external business information sources 104 into one or more business listings suitable for the business listing database 212.

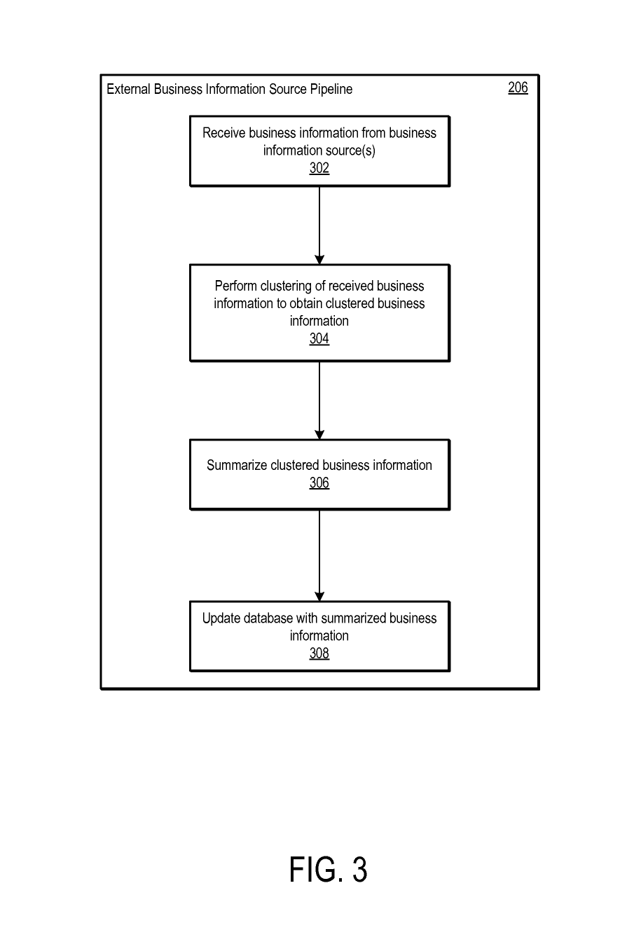

The business listing status notifier 214 is operative to notify one or more pipelines, such as the moderation candidates pipeline 208, that the moderation priority server 108 has updated the business listing database 212 with additional or updated business information regarding a new or previously existing business listing. The moderation candidates pipeline 208 is discussed below with reference to FIG. 3. In one embodiment, the business listing status notifier 214 may be an index status file for the business listing database 212 that informs the moderation candidates pipeline 208 that an update for a business listing has occurred. Based on a change in status of the business listing status notifier 214, the moderation candidates pipeline 208 may then retrieve previously clustered business information and/or the previously summarized business information from the external business information source pipeline 206.

FIG. 3 illustrates one example of an external business information source pipeline for organizing the business information received from one or more external business information sources 104. Initially, the moderation priority server 108 receives the business information from the external business information source (Block 302). Thereafter, the processor 204 may perform clustering of the received business information to obtain initial or rudimentary business listings (Block 304). The received business information may be clustered based on one or more business attributes, such as the business name, the geographical location of the business, the postal address of the business, the phone number for the business, or any other attribute or combination of attributes.

The processor 204 may then summarize the clustered business information to obtain summarized business information and/or one or more business listings (Block 306). In one embodiment, summarizing the clustered business information may include identifying which of the business attributes of the business information is most accurate or is likely to be accurate for the business. For example, during the summarizing process, the processor 204 may identify that two slightly different phone numbers are associated with a business. In this example, the processor 204 may identify one of the two phone numbers as being more accurate. The identification of the more accurate phone number may be based on a number of factors, such as the source of the business information, whether the phone number aligns with the postal address of the business, or any other factor or combination of factors. Hence, in this manner, the processor 204 is operative to organize potentially conflicting or duplicate data about a business into a business listing. The processor 204 may then update the business listing database 212 with the summarized business information (Block 308).

In some instances, updating the business listing database 212 may include updating information for a prior existing business listing. In other instances, updating the business listing database 212 may include creating a new business listing.

Once the business listing database 212 is updated, the business listing status notifier 214 may notify the moderation candidates pipeline 208 that one or more business listings are ready to be moderated. Referring to FIG. 2, the moderation candidates pipeline 208 may then retrieve the previously clustered business information for a business listing and/or retrieve the previously summarized business information for the business listing from the external business information source pipeline 206. In one embodiment, the moderation candidates pipeline 208 may feed the previously clustered business information and/or previously summarized business information to the moderation priority queue 210 for assigning a moderation priority to the business listing.

The moderation candidates pipeline 208 may retrieve the previously clustered business information and/or the previously summarized business information to assist in determining the potential problems or severity of potential problems for a given business listing. In short, the clustered business information and the summarized business information represents unabridged business information, whereas a business listing in the business database 212 may represent a reduced set of the original amount of business information that the moderation priority server 108 originally received. Hence, the previously clustered business information for a business listing may contain information not present in the business listing database 212. For example, the previously clustered business information for the business listing may contain information about the business information source, the trustworthiness of which the processor 204 may use in determining the potential problems or severity of problems for a given business listing. As another example, the clustered business information may contain the possible telephone numbers of the business, which the processor 204 may use in determining whether there is a potential problem with the telephone number of the business listing.

Similarly, the previously summarized business information may also contain information not present in the business listing database 212, such as the reasons for why the value for a particular business attribute was selected over another value. For example, the summarized business information may indicate why a particular business name (e.g., “Joe's Pizza”) was picked over another business name (e.g., “Joseph's Pizza”) for a given business listing. As with the previously clustered business information for a business listing, the processor 204 may use the previously summarized business information to determine the potential problems and/or severity of potential problems with the business listing.

The internal business information sources 106 may be operative to provide business information directly to the moderation priority queue 210 via the processor 204. The business information provided by the internal business information sources 106 may include updated information about a business listing or that there is a problem with a business listing. The processor 204 may use the reported problem with the business listing to update the moderation priority queue 210, which, as discussed below, may result in re-assigning a moderation priority to the business listing and/or determining that the business listing should be published (if identified as being suppressed) or suppressed (if identified as being published).

The moderation priority queue 210 is operative to store business listings to be moderated. The processor 204 may assign a moderation priority to the one or more business listings residing in the moderation priority queue 210. The moderation priority assigned to each of the business listings may indicate in which order the business listings are to be moderated by the one or more moderators 110.

In one scenario, the processor 204 initially estimates a probability that a business listing, denoted as variable i, is incorrect, denoted as variable fᵢ. The processor 204 may determine fᵢ based on one or more factors, such as the business information source(s) that provided the business information for the business listing, the amount of business information present in the business listing, the type of business information in the business listing, or any other factors. As discussed above with reference to the moderation candidates pipeline 208, this value may be based on the previously clustered business information and/or the previously summarized business information.

The processor 204 may also determine fᵢ based on user interaction with a business listing. For example, the processor 204 may determine fᵢ based on whether a user has viewed the business listing and then selected (e.g., clicked on) the business listing when the business listing is associated with a hyperlink. In one embodiment based on user interaction, the processor 204 may estimate fᵢ by dividing the number of views of the business listing with the number of times users have selected (e.g., “clicked”) the business listing.

The processor 204 may also estimate a severity in a problem with a business listing i, provided that the processor 204 has determined that there is a probability that the business listing has a problem. The variable sevᵢ denotes the severity in the problem with business listing i. As discussed above with reference to the moderation candidates pipeline 208, this value may also be based on the previously clustered business information and/or the previously summarized business information. The processor 204 may use the variables fᵢ and sevᵢ to distinguish business listings having a range of problems, such as where the moderation priority server 108 has estimated a problem with the business category of a business listing or where the moderation priority server has estimated a problem with business identifying information (e.g., a business phone number) with the business listing.

An example may illustrate the use of assigning fᵢ and sevᵢ. In this example, assume that the moderation priority server 108 has estimated that a business listing has a 50% chance of having a severity-10 problem and a 50% chance of having a severity-20 problem. In one example, a severity-10 problem indicates that the business listing is assigned the wrong business category, whereas a severity-20 problem indicates that the business listing has the wrong business address. The moderation priority server 108 may then determine that the business listing has a 75% chance of having a problem, with an estimated severity of 20. The moderation priority server 108 may determine this severity given that the business listing has at least one problem, ⅓ of the time having the severity-10 problem, ⅓ of the time having the severity-20 problem, and ⅓ of the time having both. While moderation priority server 108 may determine that the severities of a business listing multiply, the moderation priority server 108 may determine that the severities in the business listing sum or divide. Multiplication of the severities may indicate that one or more severities are particularly problematic (e.g., the severity of an incorrect phone number may multiply with the severity of an incorrect postal address), whereas the summation or division of severities may indicate that one or more severities are less problematic (e.g., the severity of an incorrect phone number may add with the severity of an incorrect ZIP code).

The processor 204 may then assign a penalty to publishing the business listing with one or more errors. The variable penᵢ denotes this penalty. The processor 204 may also assign a benefit to publishing the business listing without errors. The variable benᵢ denotes this benefit. The variable penᵢ may be based on multiplying sevᵢ with the expected number of impressions of the business listing, denoted as the variable impᵢ. In other words, penᵢ=sevᵢ*impᵢ. In general, an impression is the appearance of the business listing on a web page being accessed by a user. However, an impression may also be when the business listing appears on a web page, e.g., on a web page of search results. The variable benᵢ may be based on the potential number of impressions of the business listing. For example, the variable benᵢ may be defined as a linear function of the expected number of impressions for the business listing. However, the variable benᵢ may be determined as any other kind of function of the number of impressions of the business listing.

Based on determining penᵢ and benᵢ, the processor 204 may then determine a publishing value for the business listing and a suppressing value for the business listing. The publishing value and the suppressing value may determine whether the business listing is to be published. In general, the moderation priority server 108 may determine that the business listing is to be published if the expected gain of publishing the business listing outweighs the expected loss (penalty) of not publishing the business listing. The processor 204 may determine the publishing value of the business listing as benᵢ*(1−fᵢ) and the suppressing value of the business listing as penᵢ*fᵢ. Accordingly, the processor 204 may determine whether the publishing value (benᵢ*(1−fᵢ)) is greater than the suppressing value (penᵢ*fᵢ); or, in other words whether benᵢ*(1−fᵢ)>penᵢ*fᵢ. The expected outcome from this determination, assuming that the business listing is not moderated, is thus max(benᵢ*(1−fᵢ)−penᵢ*fᵢ, 0). Since the expected outcome of moderating any business listing may be benᵢ, the expected gain of moderating any business listing may be benᵢ−max (benᵢ−fᵢ (benᵢ+penᵢ), 0)

From the determination of the publishing value and the suppressing value, the processor 204 assigns a moderation priority to the business listing in the moderation priority queue 210. In one embodiment, when the publishing value exceeds the suppressing value, the processor 204 assigns a moderation priority of fᵢ*(benᵢ+penᵢ) to the business listing. Similarly, when the suppressing value exceeds the publishing value, the processor 204 assigns a moderation priority of benᵢ to the business listing.

In addition to assigning a moderation priority to the business listing, the processor 204 may also update the business listing database 212 with whether the business listing is to be published or suppressed. In one embodiment, the processor 204 updates the business listing database 212 that the business listing is to be published when the publishing value exceeds the suppressing value, and updates the business listing database 212 that the business listing is to be suppressed when the suppressing value exceeds the publishing value.

Furthermore, a moderation priority assigned to a business listing may not be static. Rather, the moderation priority assigned to the business listing may change as additional or updated business information is received from the external business information sources 104 and/or the internal business information sources 106. When the moderation priority server 108 receives additional or updated business information for a business listing, the processor 204 may re-determine the publishing value for the business listing. Re-determining the publishing value for the business listing may be based on a probability that the updated business information is accurate. In addition, re-determining the publishing value may include re-determining one or more values used in determining the publishing value, such as benᵢ, fᵢ, the expected number of impressions for the business listing, or any other value.

The processor 204 may also re-determine the suppressing value for the business listing. As with re-determining the publishing value, re-determining the suppressing value may include re-determining one or more values used in determining the suppressing value, such as penᵢ, fᵢ, sevᵢ, or any other value used in determining the suppressing value.

The processor 204 may then re-assign a moderation priority to the business listing based on whether the re-determined publishing value exceeds the re-determined suppressing value. It should be recognized that, depending on the outcome of re-determining the publishing and suppressing values, that the re-assigned moderation priority may be different than the moderation priority initially assigned to the business listing. In this manner, the moderation priority server 108 may ensure that updated business information for a business listing is taken into account in the moderation process.

The processor 204 may also sort one or more of the business listings in the moderation priority queue 210 according to an amount of moderation time required to moderate the one or more business listings. As different types of moderations may require different amounts of time on behalf of one or more of the moderators 110, the moderation priority server 108 may sort the moderation priority queue 210 accordingly. In one embodiment, the moderation priority server 108 may define the time cost of moderating a business listing as the variable mod_timeᵢ. In this embodiment, the processor 204 may sort the business listings in the moderation priority queue 210 according to the equation:

$$\frac{{ben}_{i} - max ( {ben}_{i} - {f}_{i} ( {ben}_{i} + {pen}_{i} , 0 ) )}{{mod\_time}_{i}} .$$

The moderation priority server 108 may also prioritize the business listings based on whether a business listing is expected to be removed from the business listing database 212 after being moderated. In many instances, a business listing that the moderation priority server 108 determines should be suppressed may ultimately be removed from the business listing database 212, such as when the business listing is determined to be a fake business listing or to have too many errors to correct.

Assuming that business listings will be removed from the business listing database 212 after being moderated, the moderation priority server 108 may define the value of publishing business listings that, after moderation, may require some corrections and the value of publishing business listings that, after moderation, will be deleted from the business listing database 212. A variable benᵢ_{_{—}}_{good} may represent the value of publishing a business listing where there is nothing actually incorrect with the business listing.

A variable benᵢ_{_{—}}_{bad} may represent the value of correcting and potentially publishing a listing in the instance where the business listing actually has a problem. In one embodiment, the variable benᵢ_{_{—}}_{bad} may be defined as benᵢ_{_{—}}_{bad}=benᵢ_{_{—}}_{good}*(1−(percent of business listing corrections that are business listing deletions). Accordingly, when the suppressing value of a business listing exceeds its publishing value, the processor 204 may assign a moderation priority of benᵢ_{_{—}}_{bad} (instead of benᵢ) to the business listing. When the publishing value of the business listing exceeds its suppressing value, the processor 204 may assign the business listing a moderation priority of ((benᵢ_{_{—}}_{good}*(1−fᵢ))+((fᵢ*benᵢ_{_{—}}_{bad}))−(((1−fᵢ)*benᵢ_{_{—}}_{good})+(fᵢ*penᵢ)), which may reduce to fᵢ*(benᵢ_{_{—}}_{bad}−penᵢ).

To establish the percent of business listing corrections that are business listing deletions, the moderation priority server 108 may monitor the number of suppressed and/or published business listings that are deleted from the business listing database 212 by the moderators 110. The moderation priority server 108 may monitor the number of business listing deletions over a predetermined period of time, such as one hour, one day, one week, one year, etc.

In another embodiment, the moderation priority server 108 may account for whether a suppressed business listing has a fatal problem that may cause a moderator to delete the business listing from the business listing database 212. For example, the moderation priority server 108 may define the variable benᵢ_{_{—}}_{bad} as benᵢ_{_{—}}_{good}*(1−(the probability that the business listing has a fatal problem, given that is has a problem)). To establish the probability of a suppressed business listing having a fatal problem, the moderation priority server 108 may query the moderators 110 as to the reason for the deletion of the business listing. The moderation priority server 108 may then compare the number of problems that resulted in deleting a business listing against the number of problems that resulted in the correction of a business listing, but not its removal from the business listing database 212.

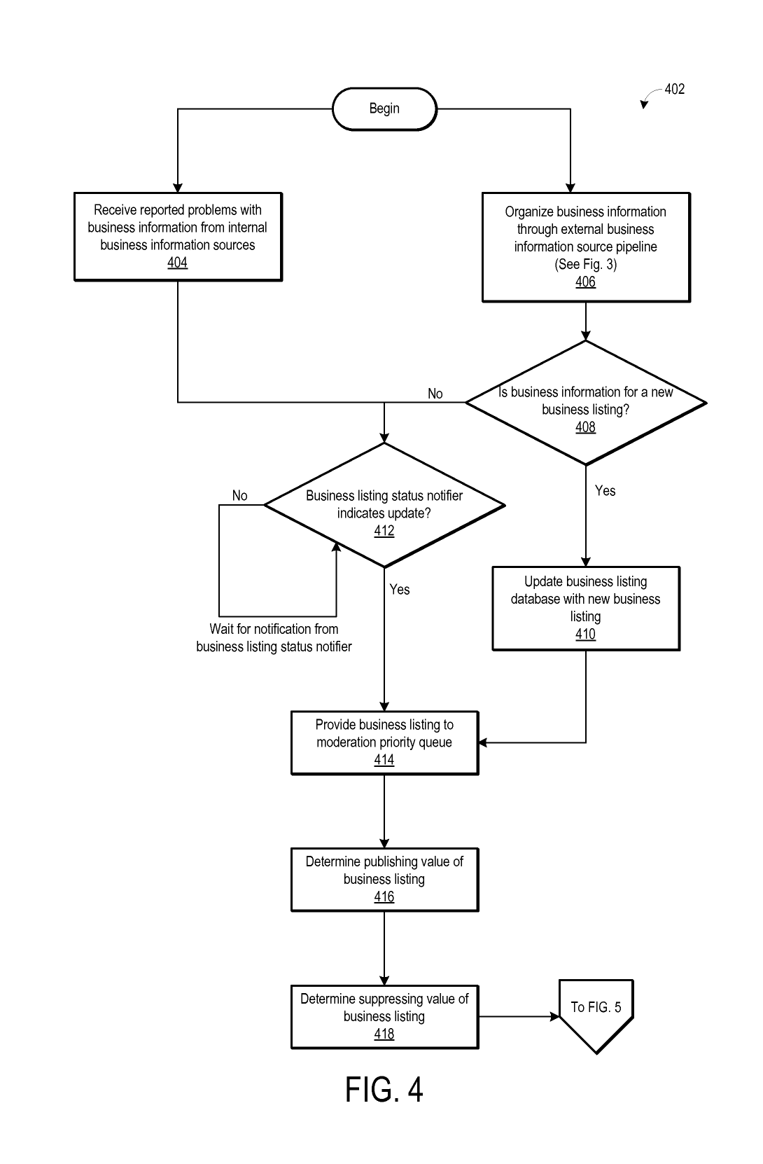

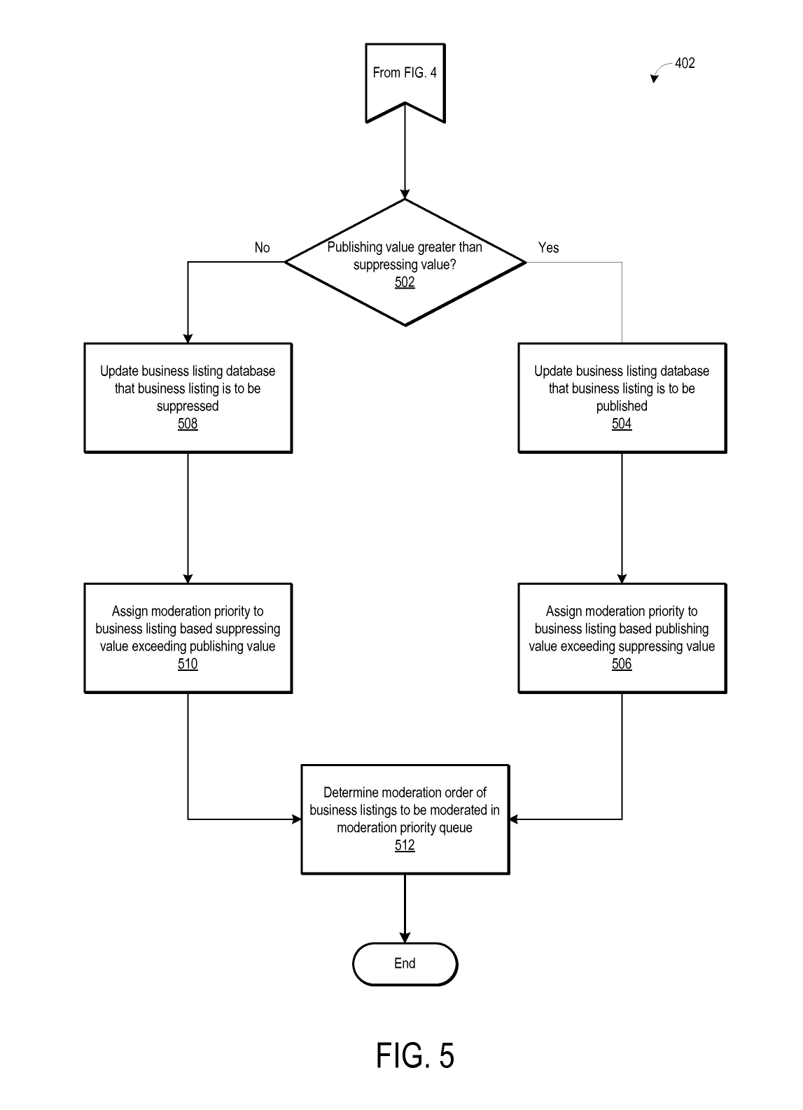

FIGS. 4-5 present an example of logic flow 402 for assigning a priority to a business listing for moderation (FIG. 5 is a continuation of FIG. 4). Initially, the moderation priority server 108 receives business information from the internal business information sources 106 and the external business information sources 104. As discussed previously, the business information from the internal business information sources 104 may be reports of problems with one or more business listings (Block 404) and the business information from the external business information sources 106 may be raw data or other data about a business. The processor 204 may also organize the business information received from the external business information sources 104 (Block 406). As discussed previously, the organization of the business information received from the external business information sources 104 may occur by leveraging the external business information source pipeline 206 (See FIG. 3).

Where the business information is received from the external business information sources 104, the processor 204 (or a user of the moderation priority server 108) may decide whether the business information is for a new business listing or whether the business information is for updating a previously existing business listing (Block 408). Where the business information is for a new business listing, the processor 204 may create a business listing to be inserted into the business listing database 212 (Block 410). Once the business listing database 212 is updated, the processor 204 may change the status of the business listing status notifier 214 to indicate that the business listing database 212 has been updated.

Where the received business information is for a previously existing business listing in the business listing database 212, the processor 204 may update the previously existing business listing accordingly. Whether the received business information is for a previously existing business listing or a new business listing, the processor 204 may provide the received business information to the moderation candidates pipeline 208.

As business information is being provided to the moderation candidates pipeline, the moderation priority server 108 may check the business listing status notifier 214 to determine whether updated business information has been provided (Block 412). When updated business information has not been provided, the moderation priority server 108 may wait for notification from the business listing status notifier to indicate that updated business information has been provided. Updated business information may also include business information for creating a new business listing in the business listing database 212. When updated business information is provided, the updated business information may be transferred from the moderation candidates pipeline 208 to the moderation priority queue 210 for assigning a moderation priority to the business listing associated with the business information (Block 414). As discussed previously, the processor 204 may determine a publishing value, which may be equal to benᵢ*(1−fᵢ), (Block 416) and a suppressing value, which may be equal to penᵢ*fᵢ, (Block 418) in assigning a moderation priority to the business listing.

Referring now to FIG. 5, the processor 204 then evaluates the determined publishing value and the determined suppressing value to determine whether the business listing is to be published or suppressed (Block 502). When the publishing value exceeds the suppressing value, the processor 204 may update the business listing database 212 to indicate that the business listing is to be published (Block 504) and may assign a moderation priority of fᵢ*(benᵢ+penᵢ) to the business listing (Block 506). In another embodiment, when the publishing value exceeds the suppressing value, the moderation priority of the business listing may be fᵢ*(benᵢ_{_{—}}_{good} penᵢ).

When the suppressing value exceeds the publishing value, the processor 204 may update the business listing database 212 to indicate that the business listing is to be suppressed (Block 508) and may assign a moderation priority of benᵢ to the business listing (Block 510). In another embodiment, when the suppressing value exceeds the publishing value, the moderation priority of the business listing may be benᵢ_{_{—}}_{bad}. After assigning the moderation priority to the business listing, the processor 204 may then determine the moderation order of the business listings waiting for moderation in the moderation priority queue 210 (Block 512). As discussed previously, the processor 204 may also determine the moderation priority of the business listings based on the expected moderation time for moderating the business listings.

In this manner, the moderation priority server 108 facilitates an expeditious moderation of business listings by one or more moderators 110. With the assignment of moderation priorities, a moderator is informed as to which business listings should be moderated first (or last) and, potentially, which business listings are expected to have the most severe or less severe problems. In addition, because the moderation priority server 108 accounts for updated business information, the moderation priority server 108 may re-prioritize a business listing and change its status (published or suppressed) based on the newly received business information. Thus, the flexibility of the moderation priority server 108 to consider updated business information in prioritizing a business listing enhances the likelihood that a business listing will not be prioritized on older or outdated information.

The moderation priority server 108 described above may be implemented in a single system or partitioned across multiple systems. In addition, the memory 202 may be distributed across many different types of computer-readable media. The memory 202 may include random access memory (“RAM”), read-only memory (“ROM”), hard disks, floppy disks, CD-ROMs, flash memory or other types of computer memory.

The business listing database 212, the external business information source pipeline 206, the moderation candidates pipeline 208, and the moderation priority queue 210 may be implemented in a combination of software and hardware. For example, external business information source pipeline 206, the moderation candidates pipeline 208, and/or the moderation priority queue 210 may be implemented in a computer programming language, such as C# or Java, or any other computer programming language now known or later developed. The pipelines 206/208 and the moderation priority queue 210 may also be implemented in a computer scripting language, such as JavaScript, PHP, ASP, or any other computer scripting language now known or later developed. Furthermore, the pipelines 206/208 and the moderation priority queue 210 may be implemented using a combination of computer programming languages and computer scripting languages.

In addition, the moderation priority server 108 may be implemented with additional, different, or fewer components. As one example, the processor 204 and any other logic or component may be implemented with a microprocessor, a microcontroller, a DSP, an application specific integrated circuit (ASIC), discrete analog or digital circuitry, or a combination of other types of circuits or logic. The business listing database 212, the pipelines 206/208, and the moderation priority queue 210 may be distributed among multiple components, such as among multiple processors and memories, optionally including multiple distributed processing systems.

Logic, such as programs, may be combined or split among multiple programs, distributed across several memories and processors, and may be implemented in or as a function library, such as a dynamic link library (DLL) or other shared library. The DLL, for example, may store code that implements functionality for a specific module as noted above. As another example, the DLL may itself provide all or some of the functionality of the system.

The business listing database 212 may be stored as a collection of data. For instance, although the business listing database 212 is not limited by any particular data structure, the business listing database 212 may be stored in computer registers, as relational databases, flat files, or any other type of database now known or later developed.

Networks 112-114 may be implemented as any combination of networks. As examples, the networks 112-114 may be a Wide Area Network (“WAN”), such as the Internet; a Local Area Network (“LAN”); a Personal Area Network (“PAN”), or a combination of WANs, LANs, and PANs. Moreover, the networks 112-114 may involve the use of one or more wired protocols, such as the Simple Object Access Protocol (“SOAP”); wireless protocols, such as 802.11a/b/g/n, Bluetooth, or WiMAX; transport protocols, such as TCP or UDP; an Internet layer protocol, such as IP; application-level protocols, such as HTTP, a combination of any of the aforementioned protocols, or any other type of network protocol now known or later developed.

Interfaces between and within the moderation priority server 108 may be implemented using one or more interfaces, such as Web Services, SOAP, or Enterprise Service Bus interfaces. Other examples of interfaces include message passing, such as publish/subscribe messaging, shared memory, and remote procedure calls.

Although aspects of the invention herein have been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the invention as defined by the appended claims. Furthermore, while certain operations and functions are shown in a specific order, they may be performed in a different order unless it is expressly stated otherwise.

1. An apparatus for an optimal prioritization of business listings for moderation, the apparatus comprising:
a memory operative to store a business listing database comprising a plurality of business listings; and
a processor in communication with the memory, the processor being operative to:
determine a publishing value for a selected business listing of the plurality of business listings based on a probability that business information for the selected business listing is accurate, wherein the publishing value indicates a value of publishing the selected business listing;
determine a suppressing value for the selected business listing based on the probability that the business information is not accurate, wherein the suppressing value indicates a value of suppressing the business listing;
assign a first moderation priority to the selected business listing that indicates a priority of the selected business listing for moderation when the publishing value exceeds the suppressing value; and
assign a second moderation priority different than the first moderation priority that indicates the priority of the selected business listing for moderation when the suppressing value exceeds the publishing value.

2. The apparatus of claim 1, wherein the processor is further operative to:
update the business listing database to indicate that the selected business listing is to be published when the publishing value exceeds the suppressing value; and
update the business listing database that the selected business listing is to be suppressed when the suppressing value exceeds the publishing value.

3. The apparatus of claim 1, wherein the processor is further operative to:
update the business information of the selected business listing with a received update of business information from a business information source;
re-determine the publishing value for the selected business listing based on a probability that the updated business information is accurate;
re-determine the suppressing value for the selected business listing based on the probability that the updated business information is not accurate;
assign a third moderation priority to the selected business listing that indicates a priority of the business listing for moderation when the re-determined publishing value exceeds the re-determined suppressing value; and
assign a fourth moderation priority different than the third moderation priority, wherein the fourth moderation priority indicates that the priority of the selected business listing for moderation when the re-determined suppressing value exceeds the re-determined publishing value.

4. The apparatus of claim 1, further comprising a moderation priority queue, wherein the processor is further operative to assign one of the first moderation priority or the second moderation priority when the moderation priority queue is populated with the selected business listing.

5. The apparatus of claim 4, wherein:
the moderation priority queue comprises a plurality of business listings to be moderated; and
the business listings to be moderated are sorted according to an amount of moderation time required to moderate each of the business listings to be moderated.

6. The apparatus of claim 1, wherein the processor is operative to determine the publishing value of the selected business listing based on an expected number of impressions for the selected business listing and an estimated probability that the selected business listing is inaccurate.

7. The apparatus of claim 1, wherein the processor is operative to determine the suppressing value of the selected business listing based on an expected number of impressions for the selected business listing and an estimated severity of a problem with the selected business listing.

8. The apparatus of claim 1, wherein the first moderation priority is based on an estimated probability that the selected business listing is inaccurate, an expected number of impressions for the selected business listing, and an estimated severity of a problem with the selected business listing.

9. The apparatus of claim 1, wherein the second moderation priority is based on an estimated linear function of an expected number of impressions for the selected business listing.

10. The apparatus of claim 1, wherein the processor is further operative to prioritize the business listing based on a probability that the selected business listing has a fatal severity when the selected business listing has a problem and the selected business listing is to be suppressed.

11. A method for an optimal prioritization of business listings for moderation, the method comprising:
establishing, in a memory, a business listing database comprising a plurality of business listings;
determining, with a processor, a publishing value for a business listing selected from the plurality of business listings, wherein the publishing value is based on a probability that business information for the selected business listing is accurate and that indicates a value of publishing the business listing;
determining a suppressing value for the selected business listing based on the probability that the business information is accurate, wherein the suppressing value indicates a value of suppressing the selected business listing;
assigning a first moderation priority to the selected business listing that indicates a priority of the selected business listing for moderation when the publishing value exceeds the suppressing value; and
assigning a second moderation priority different than the first moderation priority that indicates the priority of the selected business listing for moderation when the suppressing value exceeds the publishing value.

12. The method of claim 11, further comprising:
indicating in the business listing database that the selected business listing is to be published when the publishing value exceeds the suppressing value; and
indicating in the business listing database that the selected business listing is to be suppressed when the suppressing value exceeds the publishing value.

13. The method of claim 11, further comprising:
updating the business information of the selected business listing with a received update of business information from a business information source;
re-determining the publishing value for the selected business listing based on a probability that the updated business information is accurate;
re-determining the suppressing value for the selected business listing based on the probability that the updated business information is not accurate;
assigning a third moderation priority to the selected business listing that indicates a priority of the selected business listing for moderation when the re-determined publishing value exceeds the re-determined suppressing value; and
assigning a fourth moderation priority different than the third moderation priority, wherein the fourth moderation priority indicates the priority of the selected business listing for moderation when the re-determined suppressing value exceeds the re-determined publishing value.

14. The method of claim 11, further comprising assigning the selected business listing one of the first moderation priority or the second moderation priority when a moderation priority queue is populated with the selected business listing.

15. The method of claim 14, wherein the moderation priority queue comprises a plurality of business listings to be moderated; and the method further comprises:
sorting the business listings to be moderated according to an amount of moderation time required to moderate each of the business listings to be moderated.

16. The method of claim 11, wherein determining the publishing value of the selected business listing is based on an expected number of impressions for the selected business listing and an estimated probability that the selected business listing is inaccurate.

17. The method of claim 11, wherein determining the suppressing value of the selected business listing is based on an expected number of impressions for the selected business listing and an estimated severity of a problem with the selected business listing.

18. The method of claim 11, wherein determining the first moderation priority is based on an estimated probability that the selected business listing is inaccurate, an expected number of impressions for the selected business listing, and an estimated severity of a problem with the selected business listing.

19. The method of claim 1, wherein determining the second moderation priority is based on an estimated linear function of an expected number of impressions for the selected business listing.

20. The method of claim 1, wherein prioritizing the selected business listing is based on a probability that the selected business listing has a fatal severity when the selected business listing has a problem and the selected business listing is to be suppressed.
